(19) United States
(12) Patent Application Publication
(10) Pub. No.: US 2014/0146576 A1
(43) Pub. Date: May 29, 2014

(54) DUAL GATE DRIVE CIRCUIT FOR REDUCING EMI OF POWER CONVERTERS AND CONTROL METHOD THEREOF

(71) Applicant: SYSTEM GENERAL CORP., Taipei Hsien (TW)

(72) Inventor: TA-YUNG YANG, MILPITAS, CA (US)

(73) Assignee: SYSTEM GENERAL CORP., Taipei Hsien (TW)

(21) Appl. No.: 14/088,633

(22) Filed: Nov. 25, 2013

Related U.S. Application Data
(60) Provisional application No. 61/730,286, filed on Nov. 27, 2012.

(51) Int. Cl. H02M 3/335

(52) U.S. Cl. CPC H02M 3/33569
USPC 363/21.02

(57) ABSTRACT

A dual gate drive circuit for a power converter and a control method are provided for reducing EMI of the power converter. The dual gate drive circuit comprises a switch and a switching control circuit. The switch is coupled to a transformer of the power converter to switch the transformer for regulating an output of the power converter. The switching control circuit generates a first switching signal and a second switching signal in response to a feedback signal to switch the switch for switching the transformer. The feedback signal is correlated to the output of the power converter. The second switching signal is enabled after a time delay once the first switching signal is enabled.

### BACKGROUND OF THE INVENTION

1. Field of Invention

The present invention relates to a power converter, and more specifically relates to a dual gate drive circuit and a control method for the power converters.

2. Description of Related Art

FIG. 1 shows a circuit diagram of a prior art of a power converter. The power converter includes a transformer 20 for transforming an input voltage V_{IN} into an output V_{O}. The transformer 20 has a primary winding N_{P} and a secondary winding N_{S}. The secondary winding N_{S} generates the output V_{O} at an output terminal of the power converter via an output rectifier 40 and an output capacitor 45. A first terminal of the output rectifier 40 is coupled to a first terminal of the secondary winding N_{S}. The output capacitor 45 is coupled between a second terminal of the output rectifier 40 and a second terminal of the secondary winding N_{S}. The output capacitor 45 is further coupled to the output terminal of the power converter. The output V_{O} is generated at the output capacitor 45.

A first terminal of the primary winding N_{P} is coupled to receive the input voltage V_{IN}. A drain terminal and a source terminal of a transistor 15 are coupled to a second terminal of the primary winding N_{P} and a ground respectively. In other words, the transistor 15 is coupled between the primary winding N_{P} and the ground. The transistor 15 operated as a switch is applied to switch the transformer 20 in response to a switching signal S_{PWM} for regulating the output V_{O} of the power converter. The switching signal S_{PWM} is coupled to a gate terminal of the transistor 15 to switch the transistor 15 for switching the transformer 20.

A diode 70, a capacitor 71 and a resistor 72 form a first snubber circuit coupled to the primary winding N_{P} of the transformer 20 for dissipating the energy of the leakage inductance of the transformer 20. An anode of the diode 70 is coupled to the second terminal of the primary winding N_{P}. The capacitor 71 is coupled between a cathode of the diode 70 and the first terminal of the primary winding N_{P}. The resistor 72 is coupled to the capacitor 71 in parallel. A capacitor 81 and a resistor 82 develop a second snubber circuit coupled to the output rectifier 40 in parallel. The purpose of equipping the snubber circuit is for reducing EMI (electromagnetic interference). A first terminal of the resistor 82 is coupled to the first terminal of the output rectifier 40 and the first terminal of the secondary winding Nₛ. The capacitor 81 is coupled between a second terminal of the resistor 82 and the second terminal of the output rectifier 40. In additional, a parasitic capacitance 17 is coupled between the drain terminal and the source terminal of the transistor 15.

FIG. 2 shows the current flow of the power converter shown in FIG. 1 when the transistor 15 of the power converter is turned on. When the transistor 15 is turned on, a charge current I_{C} will be flowed into the transformer 20 from the input voltage V_{IN} for storing the energy into the transformer 20. Meanwhile, because of Trr (reverse recovery time) of the diode 70, a surge current I_{SC1} will flow from the input voltage V_{IN} to the transistor 15 through the capacitor 71 and the diode 70. Both the charge current I_{C} and the surge current I_{SC1} will flow into the transistor 15 and cause the noise. Furthermore, because of the Trr of the output rectifier 40, another surge current I_{SC2} will backward flow through the output rectifier 40 and generate the EMI.

That is to say, the parasitic devices (such as the parasitic capacitor Cj and the wire-bond inductor Lj) of the transistor 15, the diode 70, and the output rectifier 40 form a resonant tank to generate the EMI. In additional, a switching current I_{T} will flow through the transistor 15 when the transistor 15 is turned on.

FIG. 3 shows the equivalent circuit of the resonant tank of the power converter shown in FIG 1. The Zs is the equivalent series resistance. The Zp is the equivalent parallel resistance. A higher value of the equivalent series resistance Zs and/or a lower value of the equivalent parallel resistance Zp can reduce the Q value of the resonant tank and reduce the EMI.

FIG. 4 shows the waveforms of the switching signal S_{PWM} and the switching current I_{T} of the transistor 15 of the power converter shown in FIG. 1. When the transistor 15 is turned on by the switching signal S_{PWM} (logical high level), a “resonant ringing” is generated at the leading edge of the switching current I_{T}. This resonant ringing current will produce a radiated noise and generate high EMI. One solution of reducing this EMI is to reduce the Q value of the resonant tank that is developed in the transistor 15.

### BRIEF SUMMARY OF THE INVENTION

The objective of the present invention is to provide a dual gate drive circuit and a control method for reducing EMI of the power converter.

The dual gate drive circuit for the power converter according to the present invention comprises a switch and a switching control circuit. The switch is coupled to a transformer of the power converter to switch the transformer for regulating an output of the power converter. The switching control circuit generates a first switching signal and a second switching signal in response to a feedback signal to switch the switch for switching the transformer. The feedback signal is correlated to the output of the power converter. The second switching signal is enabled after a time delay once the first switching signal is enabled.

The control method for the power converter according to the present invention comprises generating a switching signal in response to a feedback signal; generating a first switching signal and a second switching signal according to the switching signal; switching a switch of the power converter in response to the first switching signal and the second switching signal; and switching a transformer of the power converter by switching the switch for regulating an output of the power converter. The feedback signal is correlated to the output of the power converter. The second switching signal is enabled after a time delay once the first switching signal is enabled.

### BRIEF DESCRIPTION OF ACCOMPANIED DRAWINGS

The accompanying drawings are included to provide further understanding of the invention, and are incorporated into and constitute a part of this specification. The drawings illustrate embodiments of the invention and, together with the description, serve to explain the principles of the invention.

FIG. 1 shows a circuit diagram of a prior art of a power converter.

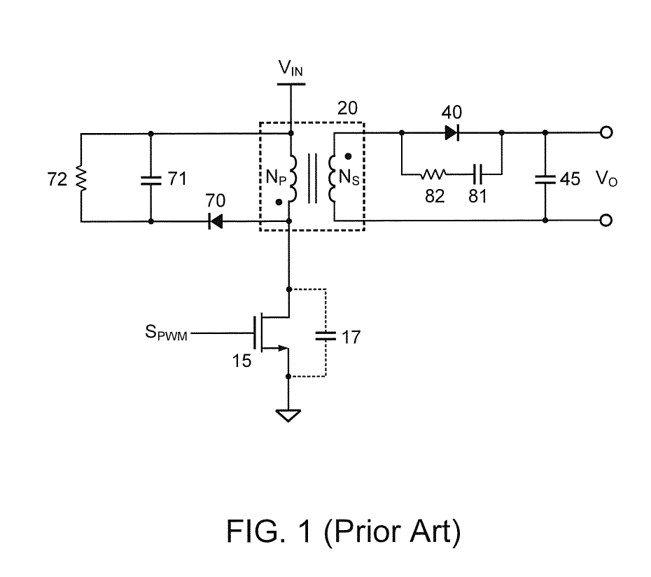

FIG. 2 shows the current flow of the power converter shown in FIG. 1 when the transistor of the power converter is turned on.

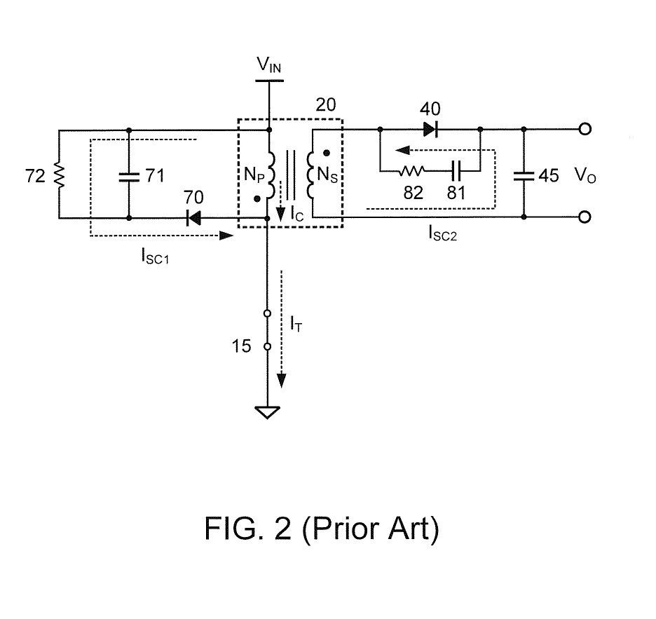

FIG. 3 shows the equivalent circuit of the resonant tank of the power converter shown in FIG. 1.

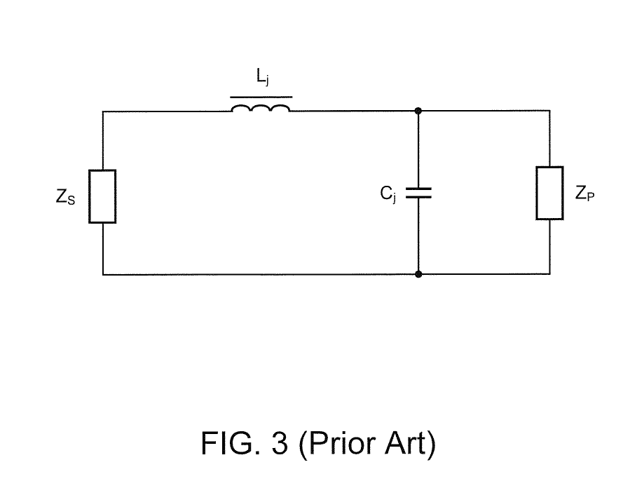

FIG. 4 shows the waveforms of the switching signal S_{PWM} and the switching current I_{T} of the transistor of the power converter shown in FIG. 1.

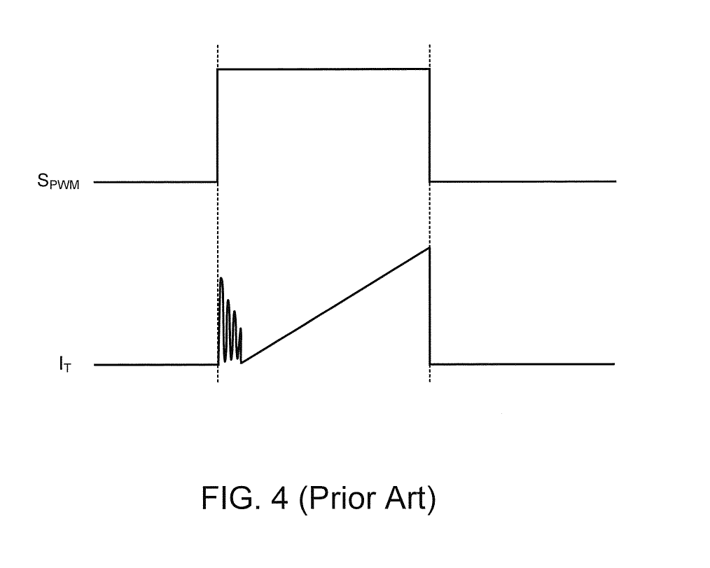

FIG. 5 is a circuit diagram of an embodiment of a dual gate drive circuit applied to a power converter according to the present invention.

FIG. 6 is a circuit diagram of an embodiment of a switching control circuit according to the present invention.

FIG. 7 shows the waveforms of the first switching signal S_{W1} and the second switching signal S_{W2} of the switching control circuit according to the present invention.

FIG. 8 is a reference circuit of a delay circuit of the switching control circuit according to the present invention.

### DETAILED DESCRIPTION OF EMBODIMENTS

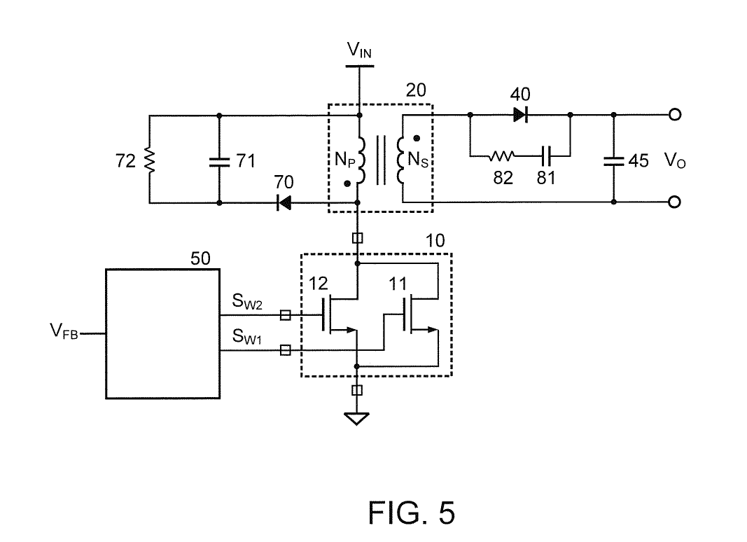

FIG. 5 is a circuit diagram of an embodiment of a dual gate drive circuit applied to a power converter according to the present invention. The power converter comprises the transformer 20. The transformer 20 has the primary winding N_{P} and the secondary winding N_{S}. The secondary winding N_{S} generates the output V_{O} at the output terminal of the power converter via the output rectifier 40 and the output capacitor 45. The first terminal of the primary winding N_{P} is coupled to receive the input voltage V_{IN}. The first snubber circuit including the diode 70, the capacitor 71 and the resistor 72 is coupled to the primary winding N_{P} of the transformer 20 for dissipating the energy of the leakage inductance of the transformer 20. The second snubber circuit including the capacitor 81 and the resistor 82 is coupled to the output rectifier 40 in parallel.

A dual gate drive circuit comprises a switch 10 and a switching control circuit 50 according to the present invention. The switch 10 is coupled between the second terminal of the primary winding N_{P} and the ground. The switch 10 is used to switch the transformer 20 for regulating the output V_{O} of the power converter. The switch 10 can include a transistor with two gate terminals or it can include two transistors. According to this embodiment, the switch 10 includes two transistors 11 and 12.

A first gate terminal develops the first transistor 11 with a high turn-on resistance (R_{DS-ON}). A second gate terminal develops the second transistor 12 with a low turn-on resistance. The high turn-on resistance of the first transistor 11 is higher than the low turn-on resistance of the second transistor 12. The second transistor 12 is coupled to the first transistor 11 in parallel. Drain terminals of the first transistor 11 and the second transistor 12 are coupled to the second terminal of the primary winding N_{P} and the anode of the diode 70. Source terminals of the first transistor 11 and the second transistor 12 are coupled to the ground. The switching control circuit 50 generates a first switching signal S_{W1} and a second switching signal S_{W2} in response to a feedback signal V_{FB} to switch the switch 10 for regulating the output V_{O} of the power converter. The feedback signal V_{FB} is correlated to the output V_{O} of the power converter. The first switching signal S_{W1} coupled to the first gate terminal of the first transistor 11 drives the first transistor 11. The second switching signal S_{W2} coupled to the second gate terminal of the second transistor 12 drives the second transistor 12.

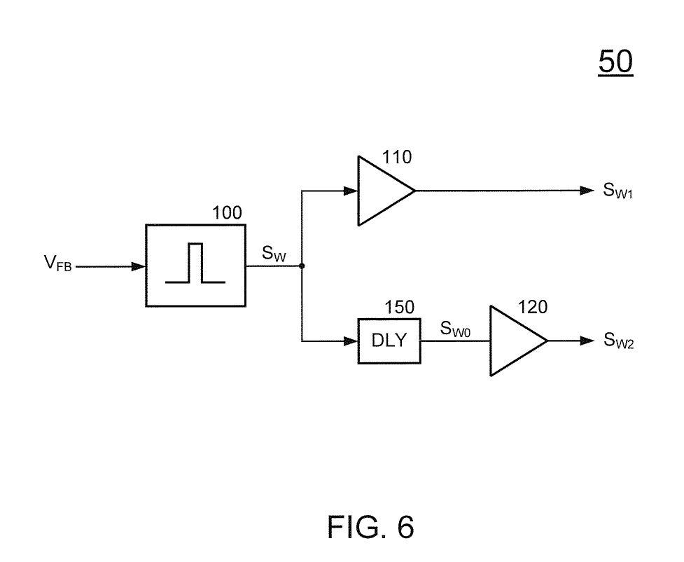

FIG. 6 is a circuit diagram of an embodiment of the switching control circuit 50 according to the present invention. As shown in FIG. 6, a controller 100 generates a switching signal S_{W} in response to the feedback signal V_{FB}. The switching signal S_{W} is utilized to generate the first switching signal S_{W1} via a first output buffer 110. The first output buffer 110 is coupled to receive the switching signal S_{W} and generates the first switching signal S_{W1} in response to the switching signal S_{W}.

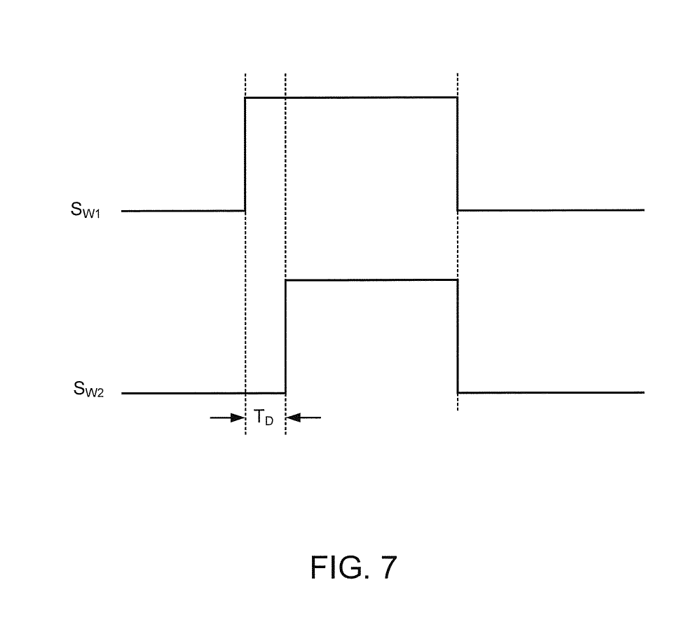

The switching signal S_{W} is further utilized to generate the second switching signal S_{W2} through a delay circuit (DLY) 150 and a second output buffer 120. The delay circuit 150 receives the switching signal S_{W} and delays the switching signal S_{W} for a time delay T_{D} (as shown in FIG. 7) to generate a delayed switching signal S_{W0}. The second output buffer 120 is coupled to receive the delayed switching signal S_{W0} and generates the second switching signal S_{W2}. Thus, the second output buffer 120 generates the second switching signal S_{W2}in response to the switching signal S_{W}. Accordingly, the switching signal S_{W} is served as a basic switching signal for generating the first switching signal S_{W1} and the second switching signal S_{W2}.

FIG. 7 shows the waveforms of the first switching signal S_{W1} and the second switching signal S_{W2} of the switching control circuit 50 (as shown in FIG. 6) according to the present invention. Once the first switching signal S_{W1} is enabled, the second switching signal S_{W2} will be enabled after the time delay T_{D}. The time delay T_{D} is developed by the delay circuit 150 (as shown in FIG. 6). The first switching signal S_{W1} and the second switching signal S_{W2} are disabled simultaneously.

Therefore, the switch 10 (as shown in FIG. 5) will be turned on with a high resistance for reducing the Q value of the resonant tank and achieving low EMI when the first switching signal S_{W1} is enabled. According to one embodiment of the present invention, the first transistor 11 with the high turn-on resistance (R_{DS-ON}) is turned on by the first switching signal S_{W1} which is enabled. After that, the switch 10 will be further turned on with a low resistance for the high efficiency. According to one embodiment of the present invention, the second transistor 12 with the low turn-on resistance will be turned on by the second switching signal S_{W2} which is enabled after the first transistor 11 is turned on. Because the second transistor 12 is coupled to the first transistor 11 in parallel and the turn-on resistance of the second transistor 12 is low, the resistance of the switch 10 becomes the low resistance once the second transistor 12 is turned on.

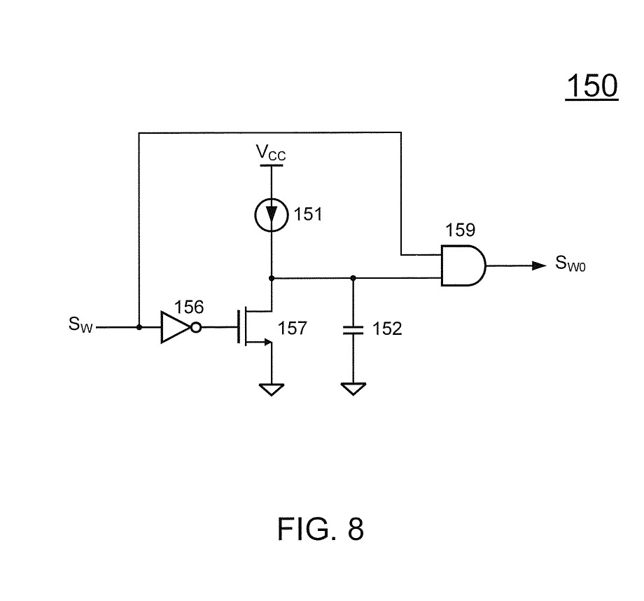

FIG. 8 is a reference circuit of the delay circuit 150 of the switching control circuit 50 according to the present invention. As shown in FIG. 8, the delay circuit 150 comprises a current source 151, a capacitor 152, an inverter 156, a transistor 157, and an AND gate 159. A first terminal of the current source 151 is coupled to a supply voltage V_{CC}. A second terminal of the current source 151 is coupled to a first terminal of the capacitor 152. A second terminal of the capacitor 152 is coupled to the ground. The current source 151 is used to charge the capacitor 152. A drain terminal of the transistor 157 is coupled to the second terminal of the current source 151 and the first terminal of the capacitor 152. A source terminal of the transistor 157 is coupled to the ground. The switching signal S_{W} is coupled to a gate terminal of the transistor 157 through the inverter 156 to control the transistor 157. The switching signal S_{W} is further coupled to a first input terminal of the AND gate 159. A second input terminal of the AND gate 159 is coupled to the capacitor 152. An output terminal of the AND gate 159 generates the delayed switching signal S_{W0}.

Once the switching signal S_{W} is enabled, the transistor 157 is turned off and the current source 151 charges the capacitor 152 for generating the delayed switching signal S_{W0} after the time delay T_{D} (as shown in FIG. 7). The time delay T_{D} is determined by the current of the current source 151 and the capacitance of the capacitor 152. The transistor 157 is coupled to discharge the capacitor 152 when the switching signal S_{W} is disabled and the transistor 157 is turned on.

Although the present invention and the advantages thereof have been described in detail, it should be understood that various changes, substitutions, and alternations can be made therein without departing from the spirit and scope of the invention as defined by the appended claims. That is, the discussion included in this invention is intended to serve as a basic description. It should be understood that the specific discussion may not explicitly describe all embodiments possible; many alternatives are implicit. The generic nature of the invention may not fully explained and may not explicitly show that how each feature or element can actually be representative of a broader function or of a great variety of alternative or equivalent elements. Again, these are implicitly included in this disclosure. Neither the description nor the terminology is intended to limit the scope of the claims.

What is claimed is:

1. A method for controlling a power converter, comprising:
generating a switching signal in response to a feedback signal;
generating a first switching signal and a second switching signal according to the switching signal;
switching a switch of the power converter in response to the first switching signal and the second switching signal; and
switching a transformer of the power converter by switching the switch for regulating an output of the power converter;
wherein the feedback signal is correlated to the output of the power converter; the second switching signal is enabled after a time delay once the first switching signal is enabled.

2. The method as claimed in claim 1, wherein a resistance of the switch is a high resistance when the first switching signal is enabled; the resistance of the switch becomes a low resistance once the second switching signal is enabled.

3. The method as claimed in claim 1, wherein the time delay is developed by a delay circuit.

4. The method as claimed in claim 1, wherein the first switching signal and the second switching signal are disabled simultaneously.

5. The method as claimed in claim 1, wherein the switch includes a transistor with two gate terminals.

6. The method as claimed in claim 1, wherein the switch includes a first transistor and a second transistor; the first transistor and the second transistor have one gate terminal respectively; the switch is coupled to the transformer to switch the transformer.

7. The method as claimed in claim 6, wherein the first transistor and the second transistor are coupled to the transformer to switch the transformer; the second transistor is coupled to the first transistor in parallel; the first transistor has a high turn-on resistance; the second transistor has a low turn-on resistance;
the first switching signal and the second switching signal are utilized to turn on the first transistor and the second transistor, respectively.

8. A dual gate drive circuit for a power converter, comprising:
a switch coupled to a transformer of the power converter to switch the transformer for regulating an output of the power converter; and
a switching control circuit generating a first switching signal and a second switching signal in response to a feedback signal to switch the switch for switching the transformer;
wherein the feedback signal is correlated to the output of the power converter; the second switching signal is enabled after a time delay once the first switching signal is enabled.

9. The dual gate drive circuit as claimed in claim 8, wherein the switch includes a transistor with two gate terminals.

10. The dual gate drive circuit as claimed in claim 8, wherein a resistance of the switch is a high resistance when the first switching signal is enabled; the resistance of the switch becomes a low resistance once the second switching signal is enabled.

11. The dual gate drive circuit as claimed in claim 8, wherein the first switching signal and the second switching signal are disabled simultaneously.

12. The dual gate drive circuit as claimed in claim 8, wherein the switching control circuit comprises:
a controller generating a switching signal in response to the feedback signal, in which the switching signal is utilized to generate the first switching signal and the second switching signal.

13. The dual gate drive circuit as claimed in claim 12, wherein the switching control circuit further comprises:
a first output buffer receiving the switching signal and generating the first switching signal in response to the switching signal;
a delay circuit delaying the switching signal for the time delay to generate a delayed switching signal; and
a second output buffer receiving the delayed switching signal and generating the second switching signal in response to the delayed switching signal.

14. The dual gate drive circuit as claimed in claim 8, wherein the switch includes a first transistor and a second transistor, the first transistor and the second transistor have one gate terminal respectively.

15. The dual gate drive circuit as claimed in claim 14, wherein the first transistor and the second transistor are coupled to the transformer to switch the transformer; the second transistor is coupled to the first transistor in parallel;
the first transistor has a high turn-on resistance; the second transistor has a low turn-on resistance; the first switching signal and the second switching signal are utilized to turn on the first transistor and the second transistor, respectively.
